(19) United States
(12) Patent Application Publication
(10) Pub. No.: US 2018/0267688 A1
(43) Pub. Date: Sep. 20, 2018

(54) INTERACTION METHOD AND DEVICE FOR CONTROLLING VIRTUAL OBJECT

(71) Applicant: Lenovo (Beijing) Co., Ltd., Beijing (CN)

(72) Inventors: Yun ZHOU, Beijing (CN); Yunhui LIU, Beijing (CN)

(21) Appl. No.: 15/920,051

(22) Filed: Mar. 13, 2018

(30) Foreign Application Priority Data
Mar. 16, 2017 (CN) 201710158701.1

(51) Int. Cl. G06F 3/0481; G06F 3/01

(52) U.S. Cl. CPC G06F 3/04815; G06F 3/017

(57) ABSTRACT

An interaction method and a device for controlling a virtual object are provided. The method includes: detecting an operating entity; determining a first parameter of the operating entity; in response to the first parameter satisfying a first condition, performing an operation on the virtual object using the operating entity; and in response to the first parameter satisfying a second condition, performing an operation on the virtual object using a displayed pointer. The displayed pointer is controllable by an action of the operating entity.

### CROSS-REFERENCES TO RELATED APPLICATIONS

This application claims priority to Chinese Patent Application No. 201710158701.1, filed on Mar. 16, 2017, the entire contents of which are hereby incorporated by reference.

### TECHNICAL FIELD

The present disclosure generally relates to the field of virtual reality (VR) and/or augmented reality (AR) and, more particularly, relates to an interaction method and a device for controlling a virtual object.

### BACKGROUND

Approaches of hand-gesture interaction using existing AR/VR glasses or head-mounted devices can basically be divided into two types: the first type is “contact interaction”, i.e., the user directly touches a virtual interface or an object displayed in front of him or her, thereby experiencing a feeling of natural control; and the second type is “cursor interaction”, i.e., instead of directly touching the virtual interface, the user uses a pointer that is similar to a cursor to reflect the position of an operating entity (e.g., a finger) on the virtual interface, thereby achieving an effect of indirect control. However, long-period operation through “contact interaction” may cause the user to feel exhausted, and the realistic level of the user experience using “cursor interaction” can be relatively weak. Thus, both interaction approaches can have the issue of relatively poor user experience.

### BRIEF SUMMARY OF THE DISCLOSURE

One aspect of the present disclosure provides an interaction method for controlling a virtual object. The method includes: detecting an operating entity; determining a first parameter of the operating entity; in response to the first parameter satisfying a first condition, performing an operation on the virtual object using the operating entity; and in response to the first parameter satisfying a second condition, performing an operation on the virtual object using a displayed pointer. The displayed pointer is controllable by an action of the operating entity.

Another aspect of the present disclosure provides a device for controlling a virtual object. The device includes a detector and a processor. The detector detects an operating entity. The processor determines a first parameter of the operating entity. In response to the first parameter satisfying a first condition, the processor performs an operation on the virtual object using the operating entity. In response to the first parameter satisfying a second condition, the processor performs an operation on the virtual object using a displayed pointer, where the displayed pointer is controllable by an action of the operating entity.

Another aspect of the present disclosure provides a computer-readable storage medium, and the computer-readable storage medium stores computer-executable instructions for execution by a processor to: drive a detector to detect an operating entity; determine a first parameter of the operating entity; in response to the first parameter satisfying a first condition, perform an operation on the virtual object using the operating entity; and in response to the first parameter satisfying a second condition, perform an operation on the virtual object using a displayed pointer. The displayed pointer is controllable by an action of the operating entity.

Other aspects of the present disclosure can be understood by those skilled in the art in light of the description, the claims, and the drawings of the present disclosure.

### BRIEF DESCRIPTION OF THE DRAWINGS

In order to illustrate technical solutions in embodiments of the present disclosure, drawings for describing the embodiments are briefly introduced below. Obviously, the drawings described hereinafter are only some embodiments of the present disclosure, and it is possible for those ordinarily skilled in the art to derive other drawings from such drawings without creative effort.

FIG. 1 illustrates a flow chart showing an example of an interaction method for controlling a virtual object;

FIG. 2A and FIG. 2B respectively illustrates a schematic view of an example of a scenario in which an interaction method for controlling a virtual object is applied;

FIG. 3 illustrates a block diagram of a device as an example for a user to control a virtual object;

FIG. 4A illustrates an example of a scenario in which a user controls a virtual object through “contact interaction”; and

FIG. 4B illustrates an example of a scenario in which a user controls a virtual object through “cursor interaction”.

### DETAILED DESCRIPTION

Various aspects, advantages, and features of the present disclosure will become apparent to those skilled in the relevant art with reference to the accompanying drawings and detailed descriptions of embodiments disclosed hereinafter. In the present disclosure, technical terms “including” and “comprising” and their derivatives may mean inclusion without limitation. Further, the term “or” is inclusive, and may mean “and/or.”

In the specification, various embodiments applied to describe principles of the present disclosure are for illustrative purposes, and shall not be construed as limiting of the scope of the present disclosure. With reference to the accompanying drawings, the following descriptions are used to fully understand exemplary embodiments defined by the claims and their equivalents of the present disclosure. Such descriptions include various specific details to aid understanding, and these details shall be considered as for illustrative purposes only.

Thus, those ordinarily skilled in the relevant art shall understand that, without departing from the scope and spirit of the present disclosure, various modifications and alterations may be made to the disclosed embodiments. Further, for clarification and conciseness, descriptions of well-known functions and structures are omitted. Throughout the accompanying drawings, the same or like reference numerals refer to the same or like structures, functions or operations.

According to various embodiments of the present disclosure, an interaction method for controlling a virtual object is provided, which can be applied to an electronic device realizing virtual reality (VR) or augmented reality (AR). Such method includes: detecting an operating entity, and determining a first parameter of the operating entity. Based on the determination result, an interaction approach of performing operational control of a virtual object sensed by a user directly through the operating entity may be applied. Alternatively, an interaction approach of performing operational control of the virtual object sensed by the user indirectly through a pointer may be applied. Further, switch between the two approaches may be realized.

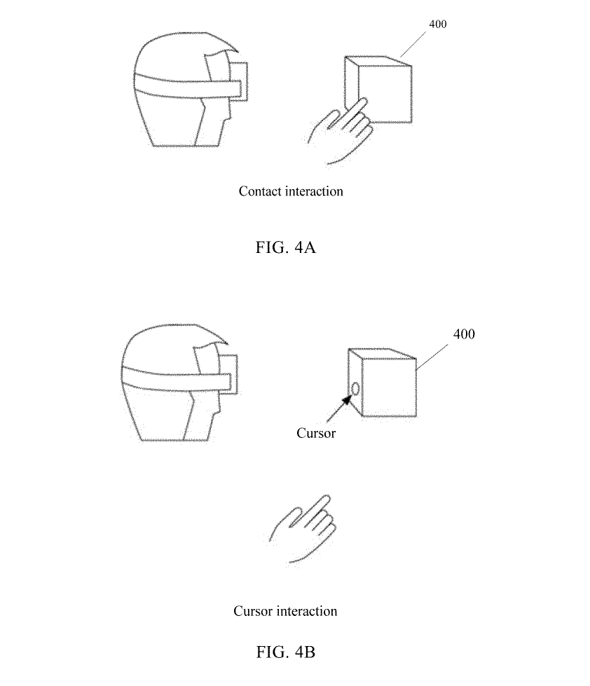

For example, FIG. 4A illustrates an example of a scenario in which a user controls a virtual object through “contact interaction”, and FIG. 4B illustrates an example of a scenario in which the user controls a virtual object through “cursor interaction”. As shown in FIG. 4A, a user wearing a pair of VR glasses may control the virtual object by directly using his hand (i.e., the operating entity) to touch the virtual object 400, and such a process may be called “contact interaction”. As shown in FIG. 4B, the user wearing a pair of VR glasses may control the virtual object 400 by generating a cursor or a pointer that moves synchronously as the hand of the user within the display space of the virtual object 400, and by performing an operation on the virtual object 400 through the cursor or the pointer. Such process may be called “cursor interaction” or “pointer interaction”.

Further, switch between the “contact interaction” in FIG. 4A and “cursor interaction” in FIG. 4B may be realized by detecting the first parameter of the hand (i.e., the operating entity), where the first parameter may be the location of the hand. For example, when the hand of the user is located within a certain range, “contact interaction” is applied, and when the hand of the user is located out of the certain range, “cursor interaction” is applied.

Further, the first parameter of the operating entity may not be limited to the location of the operating entity. For example, the first parameter of the operating entity may also include a type of the operating entity (e.g., a hand), or a posture of the operating entity (e.g., fist), etc.

Accordingly, in the aspect of controlling virtual objects, integration of direct interaction through an operating entity (“contact interaction”) and indirect interaction through a pointer (“cursor interaction”) is implemented, which combines the advantages of the two aforementioned interaction approaches and enables the user to perform flexible selection based on needs when operating the virtual objects.

FIG. 1 illustrates a flow chart showing an example of an interaction method for controlling a virtual object. As shown in FIG. 1, the interaction method for controlling a virtual object may include: detecting an operating entity (S110); determining a first parameter of the operating entity, and based on a determination result, executing S130-1 or S130-2 (S120).

At S130-1, if the first parameter satisfies a first condition, the operating entity is used to perform an operation on the virtual object. For example, if the first parameter satisfies a first condition, in response to an action of the operating entity, an operation is performed on the virtual object by the operating entity based on a location of the virtual object and the action of the operating entity.

At S130-2, if the first parameter satisfies a second condition, a pointer is displayed and used to perform on operation on the virtual object, where the displayed pointer is controllable by an action of the operating entity. For example, if the first parameter satisfies a second condition, a pointer is displayed, and the user senses the display of the pointer in a display space of the virtual object. Further, in response to the action of the operating entity, the virtual object is controlled through the pointer.

According to the present disclosure, before performing an operation on the virtual object sensed by the user, detection of any operating entity within a current detectable environmental range may be performed. When an operating entity is detected, whether the first parameter of the operating entity satisfies the first condition or second condition is determined. When the first parameter of the operating entity satisfies the first condition, in response to an action of the operating entity, an operation on the virtual object is directly performed by the operating entity based on parameters such as a location of the virtual object sensed by the user and the action of the operating entity.

Alternatively, when the first parameter of the operating entity satisfies the second condition, a pointer is displayed, and the user may sense that the pointer is displayed within the display space of the virtual object. Thus, the action of the operating entity (e.g., click) may be reflected, for example, by varying or moving the pointer, such that the virtual object may be controlled through the pointer. In other words, indirect control of the virtual object may be realized through the operating entity.

Through the disclosed method, when performing interaction control of the virtual object, the user may, based on needs, flexibly select to perform direct operation using the operating entity or perform indirect control through the pointer.

When using the operating entity to perform direct control of the virtual object, the operating entity often needs to arrive at a position of the virtual object that can be sensed by the user, for example, the user may need to feel that the operating entity is in contact with the virtual object, which allows the user to have a real sense. However, through the single approach of using the operating entity to operate the virtual object, if the duration of the operation is relatively long, the user may feel tired due to the need of walking back and forth and/or stretching the arm(s) to drive the movement of the operating entity.

Similarly, when purely using the pointer to indirectly control the virtual object, though the user no longer needs to move frequently and/or stretches his or her arm(s) frequently, which makes the user to feel more comfortable and less tired with respect to the long-period operation, the real sense experienced by the user may be relatively low.

The disclosed method, however, integrates the approach of using the operating entity to directly control the virtual object and the approach of using the pointer to indirectly control the virtual object. By such integration and based on the specific condition that the first parameter of the operating entity satisfies, the user may more conveniently and flexibly choose whether to use the operating entity for direct operation of the virtual object or use the pointer for indirect operation of the operating entity. That is, the user may flexibly select different operational approaches based on the usage intention, which improves the operational experience of the user.

The techniques and approaches for detecting an operating entity can be various.

For example, a depth camera or a sensor of a virtual reality (VR) device or an augmented reality (AR) device may be used to capture the operating entity that falls within the shooting range of the depth camera. The depth camera may be, for example, configured at a front panel of the VR or AR device to capture a real object (i.e., the operating entity) within the display region of the virtual object and surroundings thereof. In one embodiment, the depth camera is configured at the front panel of the VR or AR device to capture a hand of the user within a certain range below the front panel.

The operating entity may be a pre-configured object that can be detected and recognized. Further, the operating entity can interact with the virtual object. For example, the operating entity may be a hand of the user.

The first parameter of the operating entity may be an intrinsic property of the operating entity, a posture of the operating entity, or a location of the operating entity, etc. The intrinsic property of the operating entity may be a type of the operating entity, such as whether the operating entity is a hand or a handle. The posture of the operating entity may be the shape that the operating entity displays. For example, when the operating entity is a hand, the first parameter of the operating entity may be a posture of the hand, such as fist, index finger extension, palm-open, and the index finger and the thumb being pressed together.

Further, the location of the operating entity may be, for example, the relative position of the operating entity with respect to the display space of the virtual object. The display space of the virtual object may refer to the range of the space for displaying the virtual object observable or sensible by the user. The display space of the virtual object is often determined by the location of the VR or AR display device and the display range thereof. The relative position of the operating entity with respect to the display space of the virtual object may include following two situations: the operating entity located within the display space of the virtual object, and the operating entity located outside of the display space of the virtual object.

The approaches for determining the first parameter of the operating entity can be various based on the specific content of the first parameter of the operating entity. For example, when the first parameter of the operating entity is the type of the operating entity, under the situation in which the first parameter of the operating entity is a hand or handle, a temperature-sensitive device may be applied to determine whether the operating entity is a hand or handle by detecting the distribution and variance of the temperature of the operating entity. Under similar situations, an image recognition device may be used to recognize whether the operating entity is hand or handle. In another example, if a handle can transmit a signal to a device, whether the operating entity is a hand or handle may be determined by detecting whether there the device receives a signal transmitted by the handle, i.e., whether there is signal transmission.

Further, when the first parameter of the operating entity is the posture of the operating entity, to specifically determine whether the first parameter of the operating entity is a fist or index finger extension, etc., a device having an image recognition function may be applied to perform analysis and determination. When the first parameter of the operating entity is the location of the operating entity, determination of specific content of the first parameter may be implemented, for example, by judging whether the operating entity is within the display space of the virtual object.

Further, the aforementioned first condition may include one or a group of pre-configured parameters. The first parameter of the operating entity may be matched with the first condition. For example, matching may be performed between the first parameter and the first condition to see whether the first parameter is the same as or similar to a pre-configured parameter include in the first condition. When the first parameter of the operating entity matches the first condition, the first parameter of the operating entity is considered to have satisfied the first condition. If the first parameter of the operating entity does not match the first condition, the first parameter of the operating entity does not satisfy the first condition.

The second condition is similar to the first condition, and may also include one or a group of pre-configured parameters. Further, the first condition shall not overlap with the second condition. For example, no parameter included in the second condition should be the same as the parameter included in the first condition.

According to one embodiment of the present disclosure, the first parameter of the operating entity includes the type of the operating entity, and the type of the operating entity may include a pre-configured first type and a pre-configured second type. Specifically, when the type of the operating entity belongs to the pre-configured first type, the first parameter of the operating entity satisfies the first condition; and when the type of the operating entity belongs to the pre-configured second type, the first parameter of the operating entity satisfies the second condition.

More specifically, the first parameter of the operating entity includes the type of the operating entity, such as whether the first parameter of the operating entity is hand or handle. After categorizing types of the operating entity, a first type and a second type may be pre-configured (may referred to hereinafter as the “pre-configured first type” and “pre-configured second type”, respectively).

For example, the first type may be pre-configured to be hand, and the second type may be pre-configured to be handle. Further, specific types of the operating entity corresponding to the first type and the second type pre-configured herein may be exchanged. That is, the pre-configured first type may be handle, and the pre-configured second type may be hand. In practical implementation of the virtual reality or augmented reality, taking into consideration that using hand to directly operate the virtual object may bring improved realistic experience to the user, the pre-configured first type tends to be hand.

In one embodiment, when the first parameter of the operating entity belongs to the pre-configured first type, for example, the first parameter of the operating entity is determined to be hand which belongs to the pre-configured first type, the first parameter of the operating entity may be determined to satisfy the first condition. Under such situation, in in response to the action of the hand, based on the location of the virtual object sensed by the user and the action of the hand, operation on the virtual object is performed.

In one embodiment, when the first parameter of the operating entity belongs to the pre-configured second type, e.g., the first parameter of the operating entity is determined to be handle, the first parameter of the operating entity may be determined to satisfy the second condition. Under such situation, the pointer is displayed, which allows the user to sense that the pointer is displayed within the display space of the virtual object. Further, based on the action of the operating entity (i.e., the handle), control of the virtual object may be realized through the pointer.

According to the type of the operating entity, the present disclosure differentiates whether the virtual object is controlled directly through the operating entity or the virtual object is controlled indirectly through the pointer. Thus, when the user controls the virtual object, various operating entities are available, which allows the user to conveniently switch between different controlling manners of the virtual object.

According to another embodiment of the present disclosure, the first parameter of the operating entity includes the posture of the operating entity, and the posture of the operating entity may include a first pre-configured posture and a second pre-configured posture. When the posture of the operating entity belongs to the first pre-configured posture, the first parameter of the operating entity satisfies the first condition; and when the posture of the operating entity belongs to the second pre-configured posture, the first parameter of the operating entity satisfies the second condition.

More specifically, the first parameter of the operating entity includes the posture of the operating entity, such as index finger extension, fist, two fingers pressed together, or other postures. The first pre-configured posture and the second pre-configured posture may be set based on the shape possibly displayed by the operating entity and the need of the operation.

For example, the first pre-configured posture may include index finger extension and two fingers pressed together, etc., and the second pre-configured posture may include fist, etc. As such, when index finger extension of the user is detected, it is understood that the user may want to perform contact interaction with the sensed virtual object by using the index finger. When fist of the user is detected, it is understood that the user may want to perform indirect control on the sensed virtual object using a pointer. In on embodiment, the pointer may represent the position of a hand of the user in the display space of the virtual object, and may be a cursor in a recognizable shape, such as an arrow or a circle. Once the hand of the user moves, the cursor may move along substantially the same path. For example, the finger of the user that corresponds to the pointer may move to the left for a certain distance and correspondingly, the cursor also moves to the left for the same distance.

By using the disclosed method, when controlling the virtual object sensed nearly, the user may display the operating entity (e.g., the hand) in the first pre-configured posture, such that the user may directly operate on the sensed virtual object through an action of the operating entity. Further, for a virtual object sensed by the user that is relatively far, if the user does not need to or want to touch and/or control the virtual object directly using the hand, he or she may change the posture of the operating entity into the second pre-configured posture, thereby remotely controlling the virtual object sensed by the user that is relatively far, through a displayed pointer. Thus, the comfort of the user operation and the realistic experience of the user is greatly enhanced.

In the aforementioned method, the user only needs to change the posture of the operating entity between the first pre-configured posture and the second pre-configured posture to rapidly realize the switch between the approach of operating the virtual object directly through the operating entity and the approach of controlling the virtual object indirectly through the pointer. Thus, the convenience of switching between the two approaches is enhanced, and the user experience is improved.

According to another embodiment of the present disclosure, the first parameter of the operating entity includes the location of the operating entity. Specifically, when the operating entity is within a predetermined region with respect to the virtual object, the first parameter of the operating entity is determined to satisfy the first condition, and when the operating entity is located outside of the predetermined region with respect to the virtual object, the first parameter of the operating entity is determined to satisfy the second condition. The predetermined region with respect to the virtual object may be, for example, the display space of the virtual object.

More specifically, the first parameter of the operating entity includes the location of the operating entity, such as the relative position of the operating entity with respect to the display space of the virtual object. The display space of the virtual object may refer to the spatial range for displaying the virtual object that is observable or sensible by the user. The display space of the virtual object is often determined by the location of the VR or AR display device, as well as the display range thereof. The relative position of the operating entity with respect to the virtual object may include: the operating entity being located within the display space of the virtual object, or the operating entity being located outside of the display space of the virtual object.

When the operating entity is located within the display space of the virtual object, the first parameter of the operating entity satisfies the first condition. Under such situation, in response to the action of the operating entity, operation on the virtual object may be performed based on the location of the virtual object and the action of the operating entity sensed by the user.

When the operating entity is located outside of the display space of the virtual object, the first parameter of the operating entity satisfies the second condition. Under such situation, the pointer is displayed, and the user senses that the pointer is displayed within the display space of the virtual object. Further, in response to the action of the operating entity, the user controls the virtual object through the pointer.

In one embodiment, when the user wants to perform an operation on the virtual object directly through the operating entity, the user may place the operating entity within the display space of the virtual object. Thus, while sensing the virtual object, the user may also sense the action of the operating entity, resulting in relatively real experience. Similarly, to prevent the user from feeling tired during a long-hour operation, when needed, the user may select to place the operating entity outside of the display space of the virtual object, thereby controlling the virtual object through the pointer. In such way, the user only needs to determine whether the location of the operating entity is within the display space of the virtual object. That is, the user does not need to take into consideration the type of the operating entity nor the posture of the operating entity.

In the interaction method for controlling a virtual object according to the present disclosure, when the first parameter of the operating entity satisfies the second condition, the pointer may be displayed based on a pre-configured location mapping relationship.

As such, when the first parameter of the operating entity satisfies the second condition, a pointer is displayed. The specific display location of the pointer may be determined based on the pre-configured location mapping relationship between the space of the operating entity and the display space of the virtual object, as well as the first location of the operating entity.

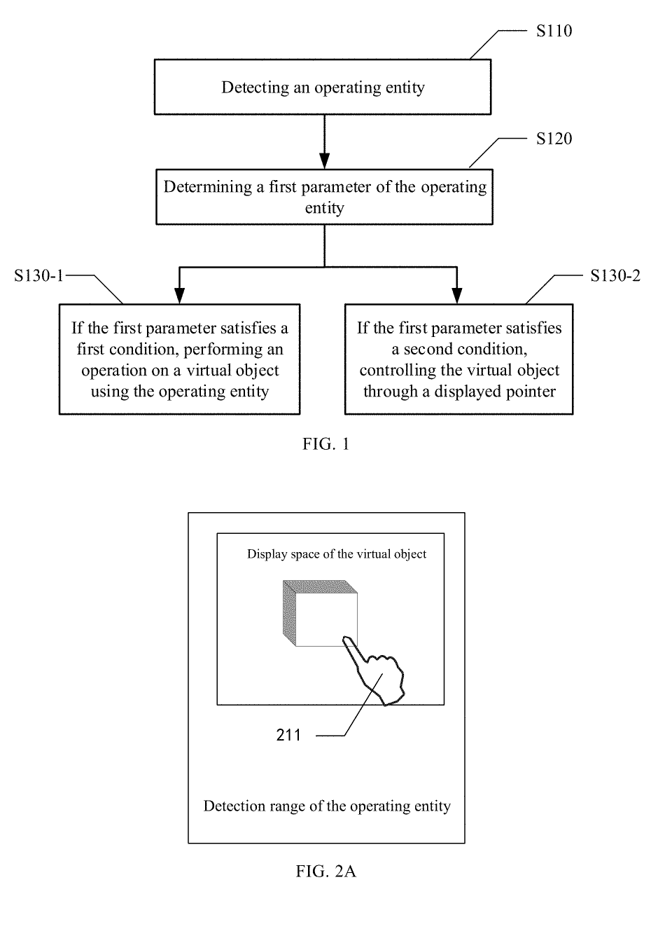

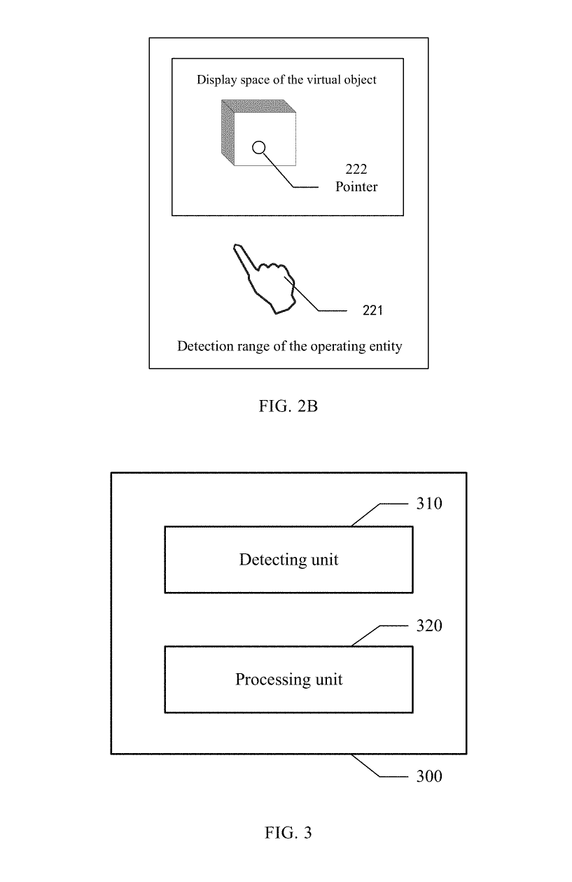

That is, the pre-configured location mapping relationship between the space of the operating entity and the display space of the virtual object may map the first location of the operating entity to a corresponding location in the display space of the virtual object, and the pointer may be displayed in the corresponding location. The specific procedure may refer to the example illustrated below (FIG. 2B).

FIG. 2A and FIG. 2B respectively illustrates a schematic view of an example of a scenario in which an interaction method for controlling a virtual object is applied. More specifically, FIG. 2A and FIG. 2B show examples of interaction for controlling the virtual object when the first parameter of the operating entity is the location of the operating entity.

In the example shown in FIG. 2A, the operating entity 211 (e.g., a hand) is located within the display space of the virtual object. In other words, the first parameter satisfies the first condition. Thus, in response to the action of the operating entity 211 (e.g., click, grasp, move or rotate), operations on the virtual object are performed based on the location of the virtual object sensed by the user and the action of the operating entity 211. For example, the virtual object may be moved or rotated.

In the example shown in FIG. 2B, the operating entity 221 is located outside of the display space of the virtual object. That is, the first parameter of the operating entity 221 satisfies the second condition. Thus, the pointer 222 is displayed, and control of the virtual object is performed through the pointer 222. The location of the pointer 222 may be obtained by mapping the location of the operating entity 221 to the display space of the virtual object based on the location mapping relationship between the space region of the operating entity 221 and the display space of the virtual object. The space region of the operating entity 221 may refer to the space outside of the display space of the virtual object and within the detection range of the detection device such as the depth camera. An example of the location of the pointer 222 may be found in FIG. 2.

Because a location mapping relationship exists between the space region of the operating entity 221 (i.e., the space outside of the display space of the virtual object but within the detection range of the detection device such as the depth camera) and the display space of the virtual object, the movement of the operating entity 221 may cause synchronous movement of the pointer 222 in the display space of the virtual object. Thus, the user may control the location of the pointer 222, and control the virtual object through the pointer 222.

The first parameter of the operating entity illustrated in FIG. 2A and FIG. 2B is the location of the operating entity, which is merely for illustrative purposes. Correspondingly, when the first parameter of the operating entity is the type of the operating entity or the posture of the operating entity, the application scenario may be similar to that in FIG. 2A and FIG. 2B, which is not repeated herein.

FIG. 3 illustrates a block diagram of a device as an example for a user to control a virtual object. As shown in FIG. 3, the disclosed device 300 for the user to control a virtual object may include a detecting unit 310 and a processing unit 320. The detecting unit 310 may be a detector, and may be configured to detect an operating entity. The processing unit 320 may be a processor, and may be configured to recognize a first parameter of the operating entity.

When the first parameter satisfies the first condition, in response to an action of the operating entity, the processing unit 320 may be configured to operate the virtual object using the operating entity based on the location of the virtual object sensed by the user and the action of the operating entity. Or, when the first parameter satisfies the second condition, the processing unit 320 may display the pointer, such that the user may sense that the pointer is displayed in the space of the virtual object, and in response to the action of the operating entity, the processing unit 320 may control the virtual object through the pointer.

In one embodiment, the detecting unit 310 detects whether an operating entity exists within a detectable environmental range. When the detecting unit 310 detects the existence of the operating entity, the processing unit 320 may recognize whether the first parameter of the operating entity satisfies the first condition or the second condition. When the first parameter of the operating entity satisfies the first condition, the processing unit 320 responds to the action of the operating entity by performing direct operation on the virtual object based on the location of the virtual object sensed by the user and the action of the operating entity. That is, when the first parameter satisfies the first condition, the processing unit 320 may perform an operation on the virtual object using the operating entity.

When the first parameter of the operating entity satisfies the second condition, the processing unit 320 displays the pointer, and enables the user to sense the existence of the pointer in the display space of the virtual object. Further, the processing unit 320 may reflect an action of the operating entity through a change in the display state of the pointer. Accordingly, by controlling the virtual object through the pointer, indirect control of the virtual object through the operating entity may be realized. In other words, when the first parameter of the operating entity satisfies the second condition, the processing unit 320 may perform an operation on the virtual object using the displayed pointer.

As such, the disclosed device 300 integrates the approach of direct operation on the virtual object through the operating entity and the approach of indirect operation on the virtual object through the pointer.

In one embodiment, the processing unit 320 classifies and processes the first parameter of the operating entity after recognizing the first parameter. By combining the aforementioned two approaches, the user may conveniently select an appropriate first parameter of the operating entity based on needs, and further determine whether to directly operate the virtual object through the operating entity or indirectly operate the operating entity through the pointer. In this way, the device 300 may enable the user to select different operational approaches based on his or her intention of usage, thus improving the operational experience of the user.

In some embodiments, the detecting unit 310 may be, for example, a depth camera in a device for virtual reality or augmented reality, which may capture the operating entity falling within the shooting range of the depth camera. The shooting range of the depth camera covers the display space of the virtual object sensed by the user.

In some embodiments, the operating entity may be any pre-configured object that is detectable and recognizable. Further, the operating entity shall be able to interact with the virtual object. For example, the operating entity may be hand, or handle, etc.

In some embodiments, the first parameter of the operating entity may be an intrinsic property of the operating entity, or a posture of the operating entity, or a location of the operating entity.

The processing unit 320 may match the first parameter of the recognized operating entity with the first condition and the second condition, respectively. When the first parameter of the operating entity matches the first condition, the first parameter of the operating entity satisfies the first condition. When the first parameter of the operating entity does not match the first condition, the first parameter of the operating entity does not satisfy the first condition.

The first condition may include one or a group of pre-configured parameters. Similar to the first condition, the second condition may also include one or a group of pre-configured parameters. Further, the second condition has no overlapping with the first condition.

According to one embodiment of the present disclosure, the first parameter of the operating entity recognized by the processing unit 320 may include the type of the operating entity. Further, when the type of the operating entity belongs to a pre-configured first type, the first parameter of the operating entity satisfies the first condition, and when the type of the operating entity belongs to a pre-configured second type, the first parameter of the operating entity satisfies the second condition.

More specifically, the first parameter of the operating entity recognized by the processing unit 320 may include the type of the operating entity, such as whether the operating entity is hand or handle. A first type and a second type of the operating entity may be pre-configured in the processing unit 320 and are thus referred to as the pre-configured first type and pre-configured second type, respectively.

For example, the first type may be pre-configured to be hand, and the second type may be pre-configured to be handle. Obviously, the specific types of the operating entities corresponding to the pre-configured first type and the pre-configured second type may be exchangeable. That is, the pre-configured first type may be handle, and the pre-configured second type may be hand. In practical implementation of virtual reality or augmented reality, taking into consideration that the user may have improved realistic feeling when using the hand to directly operate the virtual object, the pre-configured first type is usually set to be the hand.

In one embodiment, when the first parameter of the operating entity recognized by the processing unit 320 belongs to the pre-configured first type, e.g., the first parameter of the operating entity recognized by the processing unit 320 is determined to be hand which belongs to the pre-configured first type, the first parameter of the operating entity is determined to satisfy the first condition. Under such situation, the processing unit 320 may further respond to the action of the hand, based on the location of the virtual object sensed by the user and the action of the hand, to perform an operation on the virtual object.

In one embodiment, when the first parameter of the operating entity recognized by the processing unit 320 belongs to the pre-configured second type, e.g., the first parameter of the operating entity recognized by the processing unit 320 is determined to be handle which belongs to the pre-configured second type, the first parameter of the operating entity may be determined to satisfy the second condition. Under such situation, the processing unit 320 may be further configured to display a pointer, which allows the user to sense that the pointer is displayed in the display space of the virtual object. Based on the action of the operating entity (i.e., handle), the processing unit 320 may control the virtual object through the pointer.

As such, based on the type of the operating entity, the processing unit 320 differentiates whether direct operation is performed on the operating entity or the operating entity is controlled indirectly through the pointer. Thus, when performing control on the virtual object, the user may select from various types of operating entities, which allows the user to conveniently switch between controlling approaches of the virtual object.

According to another embodiment of the present disclosure, the first parameter of the operating entity recognized by the processing unit 320 includes the posture of the operating entity. When the posture of the operating entity belongs to a first pre-configured posture, the first parameter of the operating entity satisfies the first condition; and when the posture of the operating entity belongs to a second pre-configured posture, the first parameter of the operating entity satisfies the second condition.

More specifically, the first parameter of the operating entity recognized by the processing unit 320 may include the posture of the operating entity, such as index finger extension, fist, two fingers pressed together, or other postures.

The processing unit 320 may configure the first pre-configured posture and the second pre-configured posture based on the state or shape possibly displayed by the operating entity and the need of the operation. For example, the first pre-configured posture may include the index finger extension and two fingers pressed together, etc., and the second pre-configured posture may include fist, etc.

As such, when the processing unit 320 recognizes that the index finger of the user extends out, the processing unit 320 may perform an operation on the virtual object based on the location of the virtual object sensed by the user and the action of the user (i.e., extending the index finger). When the processing unit 320 recognizes that it is a fist, the processing unit 320 may display the pointer, enable the user to sense that the pointer is displayed in the space of the virtual object, and in response to the action of the hand (i.e., the fist), the processing unit 320 controls the virtual object through the pointer.

The disclosed device 300 may change the posture of the operating entity to switch the controlling approach of the virtual object. For example, when the user controls the virtual object sensed nearly, the operating entity may be displayed in the first pre-configured posture, such that the user can directly operate on the sensed virtual object through an action of the operating entity. However, for a virtual object sensed by the user that is relatively far, if the user does not need to or want to touch and/or control the virtual object directly using the hand, he or she may change the posture of the operating entity into the second pre-configured posture and remotely control the virtual object sensed by the user that is relatively far through the pointer. Thus, the comfort degree of the user operation and the sense of reality for the user may be greatly enhanced.

The disclosed device 300 may enable the user to change the posture of the operating entity between the first pre-configured posture and the second pre-configured posture, thereby rapidly realizing the switch between the approach of operating the virtual object through the operating entity and the approach of controlling the virtual object indirectly through the pointer. Thus, the convenience of switching between the two approaches is enhanced, and the user experience is improved.

According to another embodiment of the present disclosure, the first parameter of the operating entity recognized by the processing unit 320 includes the location of the operating entity. Specifically, when the operating entity is within a predetermined region with respect to the virtual object (e.g., the display space of the virtual object), the first parameter of the operating entity is determined to satisfy the first condition. Further, when the operating entity is located outside of the predetermined region with respect to the virtual object (e.g., the display space of the virtual object), the first parameter of the operating entity is determined to satisfy the second condition.

In the disclosed device 300, the first parameter of the operating entity recognized by the processing unit 320 includes the location of the operating entity, such as the relative position of the operating entity with respect to the display space of the virtual object. The display space of the virtual object may refer to the space range for displaying the virtual object observable or sensible by the user. The display space of the virtual object is often determined by the location of the display device for virtual reality or augmented reality and the display range thereof. The relative position of the operating entity with respect to the display space of the virtual object may include following situations: the operating entity being located within the display space of the virtual object, or the operating entity being located outside of the display space where the virtual object is.

When the operating entity is located within the display space of the virtual object, the first parameter of the operating entity satisfies the first condition. Under such situation, in response to an action of the operating entity, the processing unit 320 performs an operation on the virtual object based on the location of the virtual object sensed by the user and the action of the operating entity.

When the operating entity is located outside of the display space of the virtual object, the first parameter of the operating entity satisfies the second condition. Under such situation, the processing unit 320 displays the pointer, such that the user senses that the pointer is displayed in the display space of the virtual object. In response to the action of the operating entity, the processing unit 320 further controls the virtual object through the pointer.

The disclosed device 300 may place the operating entity in the display space of the virtual object when the user wants to perform an operation on the virtual object directly through the operating entity. Thus, while sensing the virtual object, the user may also sense the action of the operating entity, resulting in an improved realistic experience. Similarly, to prevent the user from feeling tired after a long-hour operation, when needed, the user may select to place the operating entity out of the display space of the virtual object, thereby controlling the virtual object through the pointer. As such, only the determination regarding whether the location of the operating entity is within the display space of the virtual object is needed, and the type of the operating entity and the posture of the operating entity do not need to be considered.

Using the disclosed device 300 for controlling a virtual object, when the first parameter of the operating entity satisfies the second condition, the processing unit 320 may display a pointer specifically by: based on a pre-configured location mapping relationship and a first location of the operating entity, determining a second location in the space of the virtual object mapped from the first location of the operating entity; and displaying the pointer at the second location.

More specifically, when the first parameter of the operating entity satisfies the second condition, the processing unit 320 displays the pointer. A specific location of the pointer may be obtained by the processing unit 320 by mapping the first location of the operating entity to the display space of the virtual object based on the pre-configured location mapping relationship between the space of the operating entity and the display space of the virtual object. Further, the processing unit 320 may display the pointer at the specific location.

As such, a corresponding relationship is established between the location of the pointer and the location of the operating entity. To change the location of the pointer, the user may change the location of the operating entity. Further, synchronous change in the location of the pointer in the display space of the virtual object and in the location of the operating entity may be implemented.

Based on embodiments of the present disclosure, the aforementioned method, device, unit and/or module may be implemented by using an electronic device having the computing capacity to execute software that comprises computer instructions. Such system may include a storage device for implementing various storage manners mentioned in the foregoing descriptions. The electronic device having the computing capability may include a device capable of executing computer instructions, such as a general-purpose processor, a digital signal processor, a specialized processor, a reconfigurable processor, etc., and the present disclosure is not limited thereto. Execution of such instructions may allow the electronic device to be configured to execute the aforementioned operations of the present disclosure. The above-described device and/or module may be realized in one electronic device, or may be implemented in different electronic devices. Such software may be stored in a computer readable storage medium. The computer storage medium may store one or more programs (software modules), the one or more programs may comprise instructions, and when the one or more processors in the electronic device execute the instructions, the instructions enable the electronic device to execute the disclosed method.

Such software may be stored in forms of volatile memory or non-volatile memory (e.g., storage device similar as ROM), no matter whether it is erasable or overridable, or may be stored in the form of memory (e.g., RAM, memory chip, device or integrated circuit), or may be stored in optical readable media or magnetic readable media (e.g., CD, DVD, magnetic disc, or magnetic tape, etc.). It should be noted that, the storage device and storage media are applicable to machine-readable storage device embodiments storing one or more programs, and the one or more programs comprise instructions. When such instructions are executed, embodiments of the present disclosure are realized. Further, the disclosed embodiments provide programs and machine-readable storage devices storing the programs, and the programs include codes configured to realize the device or method described in any of the disclosed claims. Further, such programs may be electrically delivered via any medium (e.g., communication signal carried by wired connection or wireless connection), and various embodiments may appropriately include such programs.

The method, device, unit and/or module according to the embodiments of the present disclosure may further use a field-programmable gate array (FPGA), programmable logic array (PLA), system on chip (SOC), system on the substrate, system on encapsulation, application-specific integrated circuit (ASIC), or may be implemented using hardware or firmware configured to integrate or encapsulate the circuit in any other appropriate manner, or may be implemented in an appropriate combination of the three implementation manners of software, hardware, and firmware. Such system may include a storage device to realize the aforementioned storage. When implemented in such manners, the applied software, hardware, and/or firmware may be programmed or designed to execute the corresponding method, step, and/or function according to the present disclosure. Those skilled in the relevant art may implement one or more, or a part or multiple parts of the systems and modules by using different implementation manners appropriately based on actual demands. Such implementation manners shall all fall within the protection scope of the present disclosure.

Though the present disclosure is illustrated and described with reference to specific exemplary embodiment of the present disclosure, those skilled in the relevant art should understand that, without departing from appended claims and the spirit and scope of the present disclosure defined equivalently, various changes may be made to the present disclosure in the manner and detail. Therefore, the scope of the present disclosure shall not be limited to the aforementioned embodiments, but shall not be only determined by the appended claims, but may be further defined by equivalents of the appended claims.

What is claimed is:

1. A method, comprising:
detecting an operating entity;
determining a first parameter of the operating entity;
in response to the first parameter satisfying a first condition, performing an operation on the virtual object using the operating entity; and
in response to the first parameter satisfying a second condition, performing an operation on the virtual object using a displayed pointer, wherein the displayed pointer is controllable by an action of the operating entity.

2. The method according to claim 1, wherein:
the first parameter of the operating entity includes a type of the operating entity;
in response to the type of the operating entity belonging to a first type, determining that the first parameter of the operating entity satisfies the first condition; and
in response to the type of the operating entity belonging to a second type, determining that the first parameter of the operating entity satisfies the second condition.

3. The method according to claim 1, wherein:
the first parameter of the operating entity includes a posture of the operating entity;
in response to the posture of the operating entity belonging to a first posture,
determining that the first parameter of the operating entity satisfies the first condition; and
in response to the posture of the operating entity belonging to a second type, determining that the first parameter of the operating entity satisfies the second condition.

4. The method according to claim 1, wherein:
the first parameter of the operating entity includes a location of the operating entity;
in response to the operating entity being located within a predetermined region with respect to the virtual object, determining that the first parameter of the operating entity satisfies the first condition; and
in response to the operating entity being located outside said predetermined region with respect to the virtual object, determining that the first parameter of the operating entity satisfies the second condition.

5. The method according to claim 1, wherein, in response to the first parameter satisfying a second condition, displaying a pointer includes:
based on a pre-configured location mapping relationship and a first location of the operating entity, determining a second location mapped from the first location of the operating entity in a space where the virtual object is; and
displaying the pointer at the second location.

6. A device, comprising:
a detector configured to detect an operating entity; and
a processor configured to:
determine a first parameter of the operating entity;
in response to the first parameter satisfying a first condition, perform an operation on the virtual object using the operating entity; and
in response to the first parameter satisfying a second condition, perform an operation on the virtual object using a displayed pointer, wherein the displayed pointer is controllable by an action of the operating entity.

7. The device according to claim 6, wherein:
the first parameter of the operating entity includes a type of the operating entity;
in response to the type of the operating entity belonging to a first type, determining that the first parameter of the operating entity satisfies the first condition; and
in response to the type of the operating entity belonging to a second type, determining that the first parameter of the operating entity satisfies the second condition.

8. The device according to claim 6, wherein:
the first parameter of the operating entity includes a posture of the operating entity;
in response to the posture of the operating entity belonging to a first posture, determining that the first parameter of the operating entity satisfies the first condition; and
in response to the posture of the operating entity belonging to a second type, determining that the first parameter of the operating entity satisfies the second condition.

9. The device according to claim 6, wherein:
the first parameter of the operating entity includes a location of the operating entity;
in response to the operating entity being located within a predetermined region with respect to the virtual object, it is determined that the first parameter of the operating entity satisfies the first condition; and
in response to the operating entity being located outside of said predetermined region with respect to virtual object, it is determined that the first parameter of the operating entity satisfies the second condition.

10. The device according to claim 6, wherein in response to the first parameter satisfying the second condition, the processor specifically:
determines a second location mapped from the first location of the operating entity in a space where the virtual object is, based on a pre-configured location mapping relationship and a first location of the operating entity, and
displays the pointer at the second location.

11. A computer-readable storage medium, the computer-readable storage medium storing computer-executable instructions for execution by a processor to:
drive a detector to detect an operating entity;
determine a first parameter of the operating entity;
in response to the first parameter satisfying a first condition, perform an operation on the virtual object using the operating entity; and
in response to the first parameter satisfying a second condition, perform an operation on the virtual object using a displayed pointer, wherein the displayed pointer is controllable by an action of the operating entity.

12. The computer-readable storage medium according to claim 11, wherein:
the first parameter of the operating entity includes a type of the operating entity;
in response to the type of the operating entity belonging to a first type, determine that the first parameter of the operating entity satisfies the first condition; and
in response to the type of the operating entity belonging to a second type, determine that the first parameter of the operating entity satisfies the second condition.

13. The computer-readable storage medium according to claim 11, wherein:
the first parameter of the operating entity includes a posture of the operating entity;
in response to the posture of the operating entity belonging to a first posture, determine that the first parameter of the operating entity satisfies the first condition; and
in response to the posture of the operating entity belonging to a second type, determine that the first parameter of the operating entity satisfies the second condition.

14. The computer-readable storage medium according to claim 11, wherein:
the first parameter of the operating entity includes a location of the operating entity;
in response to the operating entity being located within a predetermined region with respect to the virtual object, determine that the first parameter of the operating entity satisfies the first condition; and
in response to the operating entity being located outside of said predetermined region with respect to the virtual object, determine that the first parameter of the operating entity satisfies the second condition.

15. The computer-readable storage medium according to claim 11, wherein in response to the first parameter satisfying the second condition, the processor specifically:
determines a second location mapped from the first location of the operating entity in a space where the virtual object is, based on a pre-configured location mapping relationship and a first location of the operating entity, and
displays the pointer at the second location.
